(19) United States
(12) Patent Application Publication
(10) Pub. No.: US 2007/0234844 A1
(43) Pub. Date: Oct. 11, 2007

(54) Shift lever automatic lock device

(75) Inventor: Shigeo Hamano, Hakui-shi (JP)

Correspondence Address: Shigeo Hamano, 36-8 Shibagaki-machi,, Hakui-shi, Ishikawa, 925-0001, omitted

(73) Assignee: Shigeo Hamano, Hakui-shi (JP)

(21) Appl. No.: 11/732,275

(22) Filed: Apr. 4, 2007

(30) Foreign Application Priority Data
Apr. 11, 2006 (JP) JP2006-133090
Apr. 24, 2006 (JP) JP2006-145900

(51) Int. Cl. G05G 1/04

(52) U.S. Cl. 74/523

(57) ABSTRACT

A mode of the invention is the device which installs a solenoid near the shift lever, and operates an electric switch with it when the back support topples over back and by it the shift lever locks with the mobile object of the solenoid overhanging. To control a solenoid, it communicates it using the electric wiring or the remote control.

### CROSS-REFERENCE TO RELATED APPLICATIONS

There is not corresponding.

### BACKGROUND OF THE INVENTION

As for this invention, it locks a shift lever in the P position of the shift pattern of the automatic gear car.

As for the shift lever when planning the shift pattern of the automatic gear car which is an example contrary to the past, when the driver topples a back support while the engine operates and naps, it thinks that there is to shift a shift lever from the P position by the unconscious movement of the leg and the hand of the driver rarely.

### BRIEF SUMMARY OF THE INVENTION

It is the device by which the shift lever locks with the mobile object of the solenoid overhanging by installing a solenoid near the shift lever and operating an electric switch with it when the back support topples over back.

The other one is the device by which the shift lever locks with the mobile object overhanging by operating a wire with it when the back support topples over back, installing the mobile object with the spring which was supported with the folder near the shift lever.

### BRIEF DESCRIPTION OF THE DRAWING

Those descriptions are as follows.

FIG. 1 is a front view in case of operation of the lock device which installed a solenoid for the looking down.

FIG. 2 is a side view in case of operation of the lock device which installed a solenoid for the looking down.

FIG. 3 is the side view of the driving seat with the switching appliance for the electric switch.

FIG. 4 is a front view in case of operation of the lock device which installed a solenoid for the looking up.

FIG. 5 is a side view in case of operation of the lock device which installed a solenoid for the looking up.

FIG. 6 is the side view of the driving seat when using remote control.

FIG. 7 is each connection figure of the transmitter and the receiver.

FIG. 8 is a front view in case of operation of the lock device of the mobile object which retires with the wire.

FIG. 9 is a side view in case of operation of the lock device of the mobile object which retires with the wire.

FIG. 10 is the side view of the driving seat with the operation appliance of the mobile object which retires with the wire.

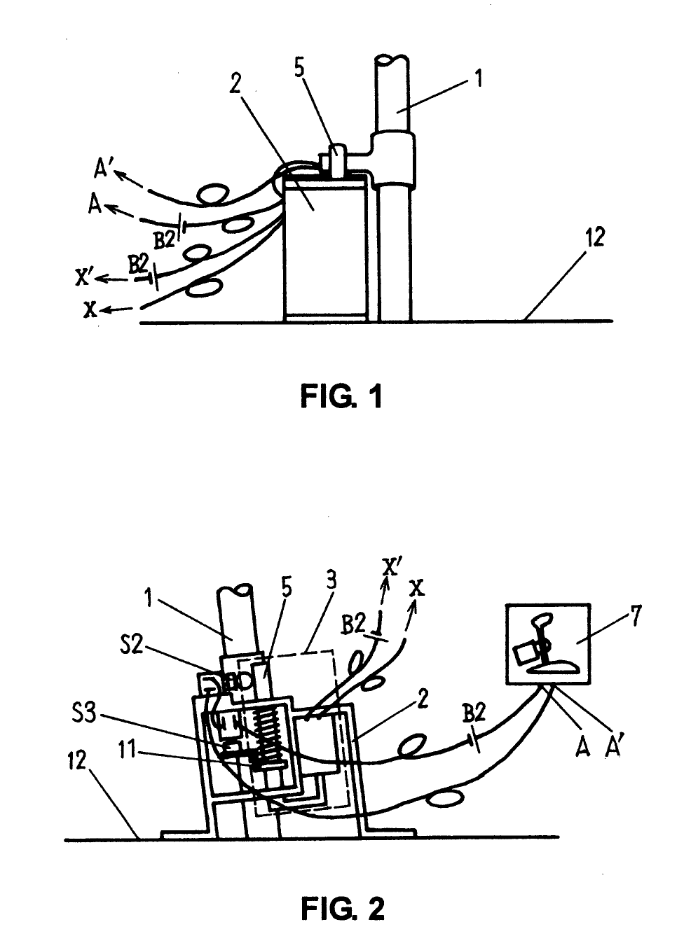

### DETAILED DESCRIPTION OF THE INVENTION

As for the invention of claim 1, the lock of the shift lever is canceled because it installs a solenoid (3) near the shift lever (1) with the folder (2), and it operates an electric switch (S1) with it at the time of the driving posture and when falling in front of the back support (4) and the mobile object (5) retires. Then, when the back support (4) topples over beyond the suitable angle back, it operates an electric switch (S1) with it, the mobile object (5) overhangs and the shift lever (1) locks by it.

As for the electric wiring to a solenoid (3) from the electric switch (S1), it passes through the rubber tube which painted slippery material and it should make tow under the driving seat (6). With ON of electric switch (S2) and electric switch (S3), the monitor (7) displays the lock of the shift lever (1) in the P position. There is not hindrance because the shift lever (1) doesn't enter to the P position only and can shift freely to the other position even if the driver topples a back support (4) back while driving and the mobile object (5) overhangs.

As for the case to use remote control for the interval of the electric switch (S1) and the solenoid (3), it operates an electric switch (S1) by the angle change of the back support (4) and the transmitter (K1) in the storage box (8) sends the electric wave to the receiver (K2). And then, it does the lock or the cancellation of the shift lever (1) with the solenoid (3) which operates by the relay of the part of the receiver (K2). It should install a receiver (K2) in the empty part inside the console box of the car.

As for the invention of claim 2, the lock of the shift lever (1) is canceled because it installs the mobile object (5) with the spring (9) which was supported with the folder (2) near the shift lever (1), and it operates a wire (10) with it at the time of the driving posture and when falling in front of the back support (4) and the mobile object (5) retires. Then, when the back support (4) topples over back beyond the suitable angle, a wire (10) with it is operated, the mobile object (5) overhangs by the spring (9) and the shift lever (1) locks by it. The mobile object (5) is 6 prisms and it is shown but it may be a suitable shape for the convenience.

When equipped with this invention to the automatic gear car when planning the shift pattern which is an example contrary to the past, the shift lever (1) is locked in the P position and doesn't shift even if the driver topples a back support (4) while the engine operates and naps and the leg and the hand of the driver do unconscious movement.

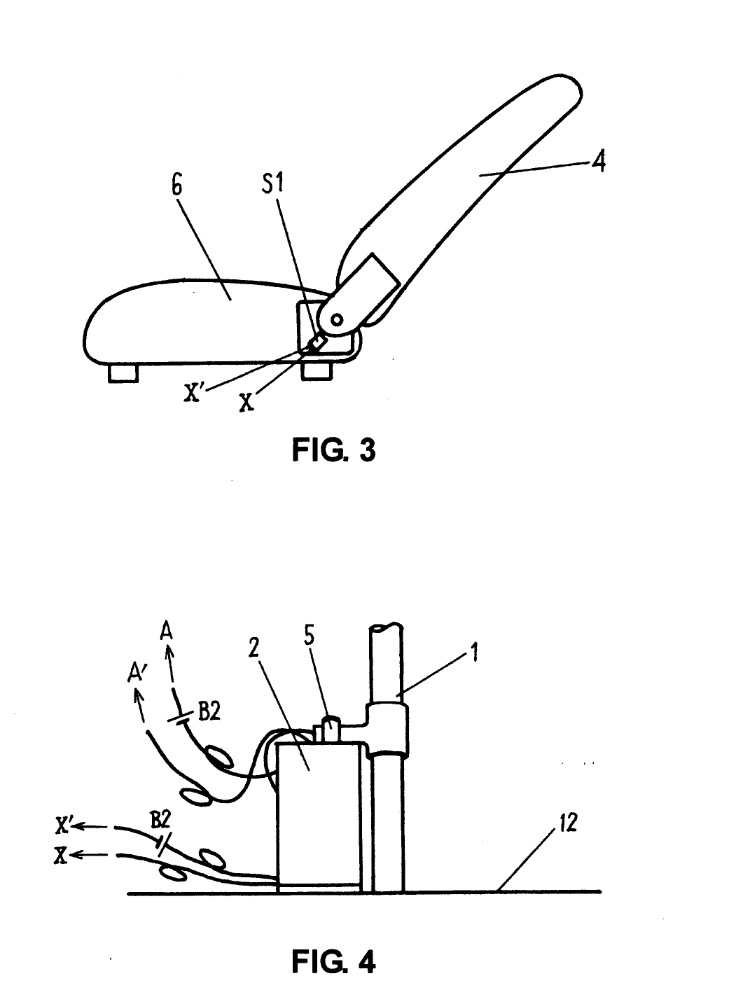

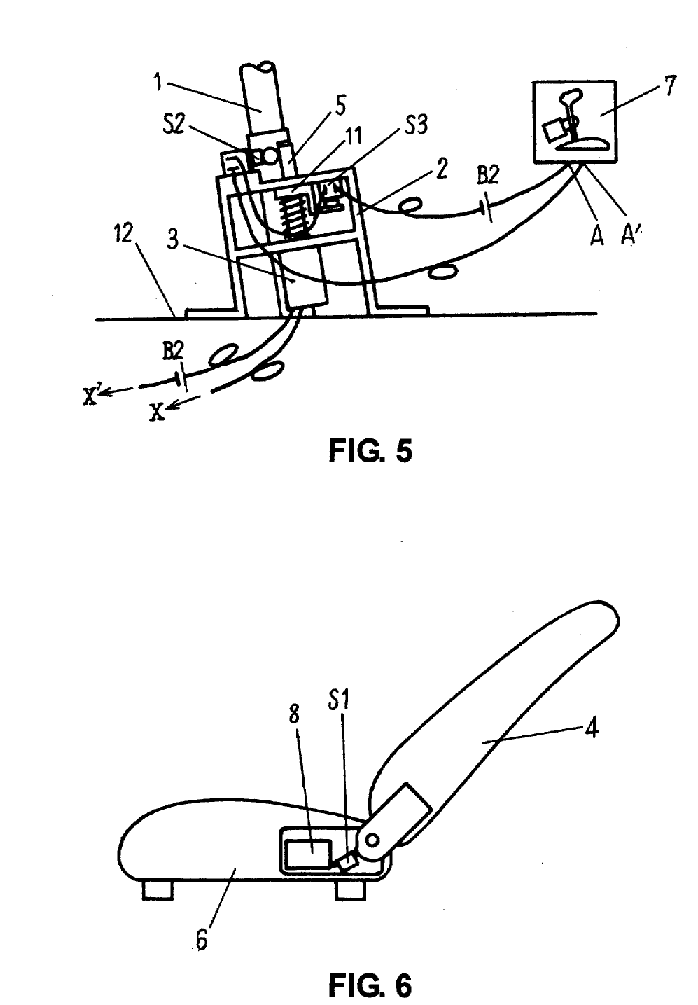

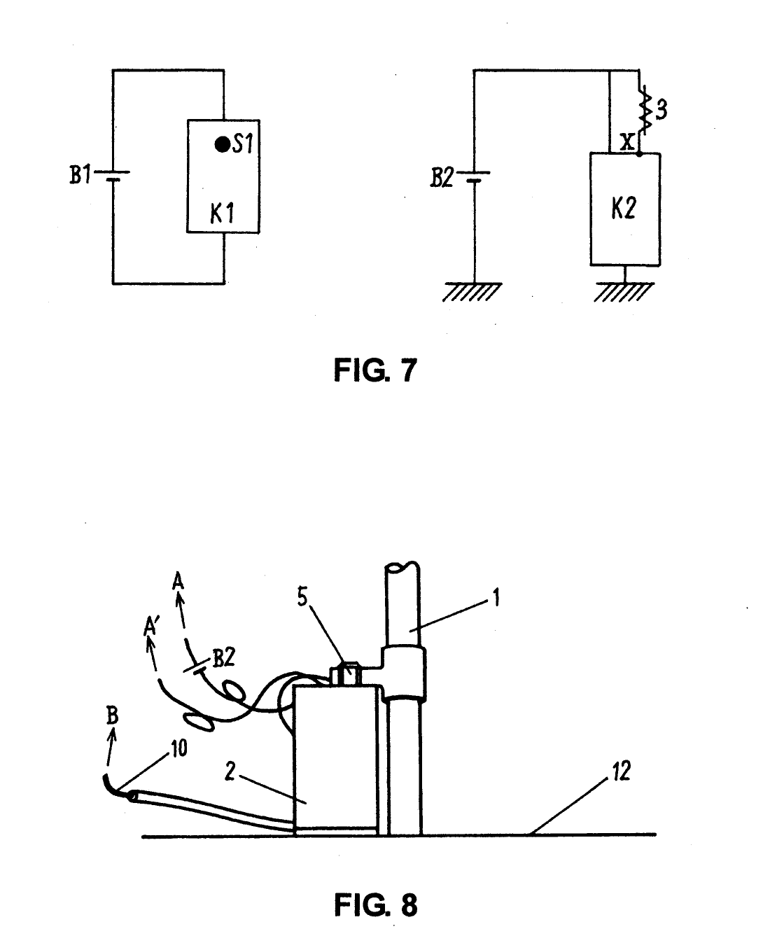

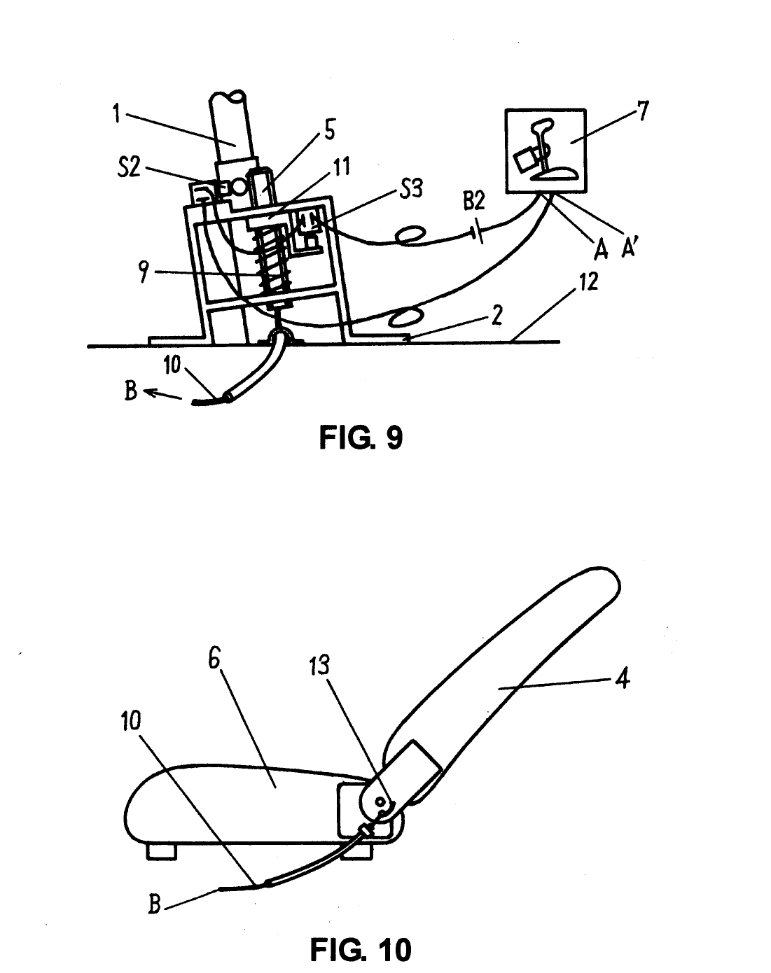

The mode of the invention to have thought that I was best as the show in FIG. 2 and FIG. 3 about operates an electric switch (S1) by the angle change of the back support (4) and by the change of the mobile object (5) of the solenoid (3), it does the lock or the cancellation of the shift lever (1).

In the figures, the mobile object (5) changes into the top and the bottom, but it installs for the side and may do the lock or the cancellation of the shift lever (1). It is easy for this invention to be installed because it is small. The figures have been drawn to be easy to understand but each part is transformable.

The reference characters were described in the following.
1: Shift Lever
2: Folder
3: Solenoid
4: Back Support
5: Mobile Object
6: Driving Seat
7: Monitor
8: Storage Box
9: Spring
10: Wire
11: Stopper and Switching Part
12: Lower Board
13: Hole which controls the Wire Effect
S1: OFF Type or ON Type Push Electric Switch
S2: Push Electric Switch
S3: Push Electric Switch
B1: Small Power
B2: Car Battery
K1: Transmitter
K2: Receiver
X: Terminal of the Relay Contact Point or Terminal of the Switch (S1)
X′: Terminal of the Switch (S1)
A: Terminal of the Monitor
A′: Terminal of the Monitor
B: Wire on the Side of the Seat

1. The invention claimed is the device by which the shift lever (1) locks with the mobile object (5) of the solenoid (3) overhanging by the operation of the electric switch (S1) when the back support (4) topples over back.

2. The invention claimed is the device by which the shift lever (1) locks with the mobile object (5) with the spring (9) which was supported with the folder (2) overhanging by the operation of the wire (10) when the back support (4) topples over back.
